(19) United States
(12) Patent Application Publication
(10) Pub. No.: US 2017/0082001 A1
(43) Pub. Date: Mar. 23, 2017

(54) DIESEL ENGINE EXHAUST GAS TREATMENT SYSTEM WITH ENHANCED NITROGEN OXIDE PURIFICATION PERFORMANCE

(71) Applicant: Hyundai Motor Company, Seoul (KR)

(72) Inventors: Jie Won PARK, Daejeon (KR); Hyo Kyung LEE, Anyang-si (KR); Pyung Soon KIM, Suwon-si (KR); Chang Ho JUNG, Osan-si (KR); Jung Min SEO, Suwon-si (KR); Jin Woo CHOUNG, Suwon-si (KR)

(21) Appl. No.: 14/946,575

(22) Filed: Nov. 19, 2015

(30) Foreign Application Priority Data
Sep. 18, 2015 (KR) 10-2015-0132283

(51) Int. Cl. F01N 3/08; F01N 3/20; F01N 3/023; B01D 53/94

(52) U.S. Cl. CPC F01N 3/0842; B01D 53/9477; F01N 3/2066; F01N 3/0231; B01D 2255/1021; B01D 2255/1023; B01D 2255/1025; B01D 2255/104; B01D 2255/106; B01D 2255/1026; B01D 2255/2065; B01D 2255/2073; B01D 2255/2063

(57) ABSTRACT

A diesel engine exhaust gas treatment system with enhanced nitrogen oxide purification performance includes a nitrogen oxide adsorption part nitrogen adsorbing oxide (NOₓ) at a temperature of less than 200° C. and desorbing the nitrogen dioxide (NO₂) at a temperature of 200° C. or more; and a nitrogen oxide purification part disposed at a lower side of the nitrogen oxide adsorption part and purifying the nitrogen oxide (NOₓ).

### CROSS-REFERENCE TO RELATED APPLICATION

This application claims the priority benefit of priority to Korean Patent Application No. 10-2015-0132283, filed on Sep. 18, 2015 in the Korean Intellectual Property Office, the disclosure of which is incorporated herein by reference.

### TECHNICAL FIELD

The present disclosure relates to a diesel engine exhaust gas treatment system with enhanced nitrogen oxide purification performance.

### BACKGROUND

In general, exhaust gas discharged through an exhaust manifold from an engine is induced to a post-treatment system, thus being purified. In addition, noise is decreased by passing through a muffler and is discharged to the atmosphere.

Here, an exhaust gas post-treatment system includes a diesel oxidation catalyst (DOC), a diesel particulate filter (DPF), a selective catalytic reduction (SCR) catalyst, etc. The SCR catalyst removes nitrogen oxide (NOₓ) from exhaust gases. However, nitrogen oxide (NOₓ) generated below a temperature at which the SCR catalyst normally operates is discharged to the atmosphere without any treatment, thus causing air pollution.

In order to address the problem, NOₓ adsorption catalyst that adsorbs NOₓ when exhaust gas is lean (when the concentration of oxygen among exhaust gases is high) and desorbs NOₓ when the concentration of oxygen among exhaust gases is low has been developed.

However, in the above NOₓ adsorption catalyst, NOₓ is discharged to the atmosphere without purification until a temperature of exhaust gas is elevated to a predetermined temperature to activate SCR.

### SUMMARY

The present disclosure has been made to address the above problems according to tightened regulations on vehicle exhaust gas. An aspect of the present inventive concept provides a diesel engine exhaust gas treatment system with enhanced nitrogen oxide purification performance which may minimize discharge of nitrogen oxide without purification at low temperature.

Another aspect of the present inventive concept provides a diesel engine exhaust gas treatment system with enhanced nitrogen oxide purification performance.

In accordance with an embodiment in the present disclosure, a diesel engine exhaust gas treatment system with enhanced nitrogen oxide purification performance comprises a nitrogen oxide adsorption part nitrogen adsorbing oxide (NOₓ) at a temperature of less than 200° C. and desorbing the nitrogen dioxide (NO₂) at a temperature of 200° C. or more; and a nitrogen oxide purification part disposed at a lower side of the nitrogen oxide adsorption part and purifying the nitrogen oxide (NOₓ).

The nitrogen oxide adsorption part may include a first oxidation catalyst adsorbing the nitrogen oxide (NOₓ) at the temperature of less than 200° C. and desorbing the nitrogen oxide (NOₓ) at the temperature of 200° C. or more; and a second oxidation catalyst with a perovskite structure disposed at a lower side of the first oxidation catalyst and oxidizing the nitrogen oxide (NOₓ) desorbed from the first oxidation catalyst.

The first oxidation catalyst may be a diesel oxidation catalyst (DOC) adsorbing or desorbing the nitrogen oxide (NOₓ) according to temperature.

The second oxidation catalyst may oxidize nitrogen monoxide (NO) to nitrogen dioxide (NO₂) at the temperature of 200° C. or more.

The second oxidation catalyst may have formula RMnO₂, wherein R is one or more selected from La and Ag.

The first oxidation catalyst may comprise: a composite oxide carrier including cerium (Ce); and a metal catalyst selected from the group consisting of palladium (Pd), platinum (Pt), rhodium (Rh), gold (Au), silver (Ag), ruthenium (Ru) and mixtures thereof.

The nitrogen oxide purification part may include a selective catalytic reduction (SCR) catalyst for purifying the nitrogen oxide (NOₓ) included in exhaust gas or a diesel particulate filter (SDPF) coated with the SCR catalyst(.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a graph illustrating a relation between nitrogen monoxide (NO) oxidation performance of a diesel oxidation catalyst (DOC) according to an embodiment in the present disclosure and temperature; and

FIG. 2 is a graph illustrating a relation between nitrogen oxide (NOₓ) adsorption amount of a diesel oxidation catalyst (DOC) according to an embodiment in the present disclosure in the new European driving cycle (NEDC) mode and exhaust gas temperature.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An embodiment in the present disclosure is to enhance purification performance of nitrogen oxide (NOₓ) by adsorbing nitrogen oxide (NOₓ) during an initial operation and at a low temperature and desorbing the nitrogen oxide (NOₓ) at a temperature at which a selective catalytic reduction (SCR) catalyst may purify the nitrogen oxide (NOₓ), in order to prevent discharge of nitrogen oxide (NOₓ) that is not sufficiently purified, in a state that a temperature of an engine is not sufficiently elevated, to the atmosphere when exhaust gas of a diesel engine is treated using a conventional selective catalytic reduction (SCR) catalyst, or a diesel particulate filter (SDPF) coated with the SCR catalyst or the like.

According to an embodiment in the present disclosure, in a diesel engine exhaust gas treatment system with enhanced nitrogen oxide (NOₓ) purification performance, a nitrogen oxide adsorption part adsorbing nitrogen oxide (NOₓ) according to a temperature and desorbing the (NOₓ) nitrogen dioxide (NO₂) by oxidizing with nitrogen oxide, and a nitrogen oxide purification part purifying the nitrogen oxide (NOₓ) are sequentially disposed according to an exhaust gas flow.

The nitrogen oxide adsorption part includes a first oxidation catalyst adsorbing or desorbing the nitrogen oxide (NOₓ) according to an internal temperature of the nitrogen oxide adsorption part and a second oxidation catalyst oxidizing the nitrogen oxide. Preferably, the first and second oxidation catalysts are sequentially disposed according to exhaust gas flow.

Accordingly, the first oxidation catalyst adsorbs nitrogen oxide (NOₓ) at a low temperature of less than 200° C. and desorbs the nitrogen oxide (NOₓ) at a temperature of 200° C. or more. Thus, poisoning due to carbon monoxide (CO) and total hydrocarbon (THC) may be prevented in a process that nitrogen monoxide (NO) is oxidized to nitrogen dioxide (NO₂) by the second oxidation catalyst.

According to an embodiment in the present disclosure, the nitrogen oxide purification part includes a SCR catalyst or a SDPF coated with the SCR catalyst. Nitrogen oxide (NOₓ) purification performance of the SCR catalyst is enhanced at a temperature of 200° C. or more.

Accordingly, when the first oxidation catalyst adsorbs nitrogen oxide (NOₓ) at a low temperature of less than 200° C. and desorbs the nitrogen oxide (NOₓ) at a temperature of 200° C. or more, nitrogen oxide (NOₓ) purification performance of the nitrogen oxide purification part may be enhanced.

In addition, in low-temperature environments such as during initial engine operation, the first oxidation catalyst according to the present disclosure adsorbs nitrogen oxide (NOₓ), and thus, discharge of unpurified nitrogen oxide (NOₓ) to the atmosphere and air pollution may be prevented.

Here, the first oxidation catalyst is a diesel oxidation catalyst (DOC) and composed of a composite oxide carrier including cerium (Ce) and a metal catalyst selected from the group consisting of palladium (Pd), platinum (Pt), rhodium (Rh), gold (Au), silver (Ag), ruthenium (Ru) and mixtures thereof. The composite oxide may include one or more selected from the group consisting of lanthanum oxide (La₂O₃), praseodymium oxide (PrO₂), neodymium oxide (Nd₂O₃), gadolinium oxide (Gd₂O₃), zirconia oxide (ZrO₂) and zeolite.

The second oxidation catalyst may be disposed in a lower part of the first oxidation catalyst in order that nitrogen monoxide (NO) among nitrogen oxides (NOₓ) desorbed from the first oxidation catalyst is oxidized to nitrogen dioxide (NO₂) when the temperature of exhaust gas is increased to 200° C. or more, and thus, the nitrogen monoxide (NO) is transferred to a nitrogen oxide (NOₓ) purification part disposed in the lower part.

Since the nitrogen oxide purification part according to the present disclosure includes at least one of the SCR catalyst and the SDPF coated with the SCR catalyst, purification is initiated at 200° C. due to characteristics the SCR catalyst and optimal purification performance is exhibited at 300° C. However, urea is sprayed during shearing and heat loss occurs, thereby making it difficult to reach 300° C. Accordingly, since the amount of NO₂ among exhaust gases is important in enhancing purification performance of NO_{R}, purification performance of the SCR catalyst may be enhanced by oxidizing NO among exhaust gases to NO₂.

Here, the second oxidation catalyst is formed into a perovskite structure having formula RMnO₃, where R may be one or more selected from La and Ag.

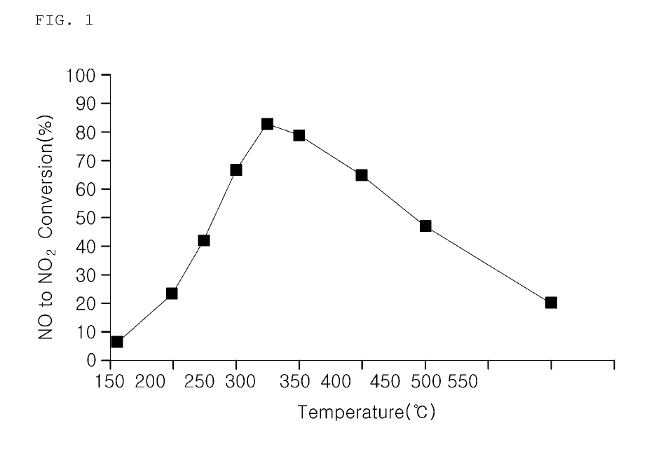

FIG. 1 is a graph illustrating a relation between nitrogen monoxide (NO) oxidation performance of the diesel oxidation catalyst (DOC) according to an embodiment in the present disclosure and temperature.

As illustrated in FIG. 1, a nitrogen monoxide (NO) transition rate of the second oxidation catalyst according to an embodiment of the present is gradually increased according to a temperature increase and a transition rate of about 70 to 80% at 250 to 300° C. is exhibited.

Accordingly, a ratio of nitrogen monoxide (NO) to nitrogen dioxide (NO₂) is controlled by changing the nitrogen monoxide (NO) among exhaust gases into nitrogen dioxide (NO₂) through oxidation, and thus, purification performance of the selective catalytic reduction (SCR) catalyst disposed in the lower part is enhanced, thereby enhancing nitrogen oxide (NOₓ) treatment efficiency.

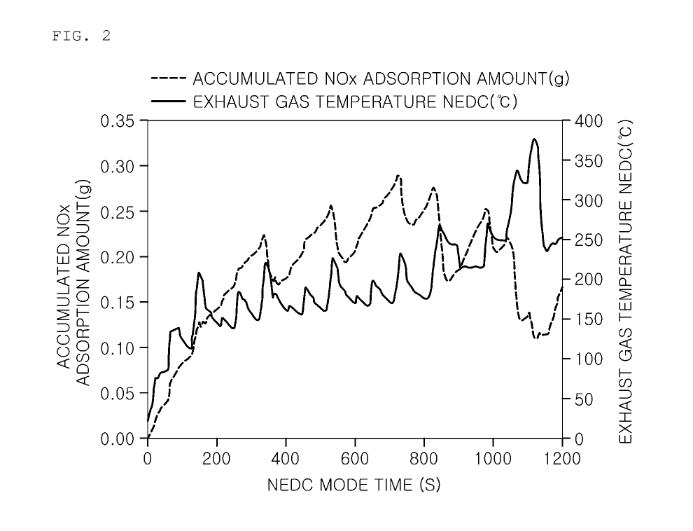

FIG. 2 is a graph illustrating a relation between adsorption amount of accumulated nitrogen oxide (NOₓ) at the new European driving cycle (NEDC) mode and exhaust gas temperature by applying the first oxidation catalyst according to an embodiment of the present invention to a general use vehicle.

As illustrated in FIG. 2, the accumulated nitrogen oxide (NOₓ) adsorption amount of the first oxidation catalyst according to the present disclosure is gradually increased at an exhaust gas temperature of less than 200° C. and nitrogen oxide is desorbed at an exhaust gas temperature of greater than 200° C.

Accordingly, the first oxidation catalyst adsorbs NOₓ at a temperature of less than 200° C. and NOₓ is desorbed at greater than 200° C. at which the second oxidation catalyst and the SCR catalyst are activated, and thus, discharge of the NOₓ to the atmosphere at a low temperature may be prevented.

According to the present disclosure, discharge of nitrogen oxide without purification at low temperature may be prevented by using a first oxidation catalyst adsorbing NOₓ at a temperature of less than 200° C. and desorbing NOₓ at a temperature of 200° C. or more, and nitrogen oxide purification performance of a nitrogen oxide purification part disposed in a lower part may be enhanced.

In addition, the first oxidation catalyst adsorbs NOₓ at a temperature of less than 200° C., and thus, poisoning of a second oxidation catalyst with a perovskite structure due to CO and THC may be prevented.

Although the embodiments in the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A diesel engine exhaust gas treatment system with enhanced nitrogen oxide purification performance comprising:
a nitrogen oxide adsorption part adsorbing nitrogen oxide (NOₓ) at a temperature of less than 200° C. and desorbing the nitrogen dioxide (NO₂) at a temperature of 200° C. or more; and
a nitrogen oxide purification part disposed at a lower side of the nitrogen oxide adsorption part and purifying the nitrogen oxide (NOₓ).

2. The diesel engine exhaust gas treatment system according to claim 1, wherein the nitrogen oxide adsorption part comprises:
a first oxidation catalyst adsorbing the nitrogen oxide (NOₓ) at the temperature of less than 200° C. and desorbing the nitrogen oxide (NOₓ) at the temperature of 200° C. or more; and
a second oxidation catalyst, which has a perovskite structure, disposed at a lower side of the first oxidation catalyst and oxidizing the nitrogen oxide (NOₓ) desorbed from the first oxidation catalyst.

3. The diesel engine exhaust gas treatment system according to claim 2, wherein the first oxidation catalyst is a diesel oxidation catalyst (DOC) adsorbing or desorbing the nitrogen oxide (NOₓ) according to temperature.

4. The diesel engine exhaust gas treatment system according to claim 2, wherein the second oxidation catalyst oxidizes nitrogen monoxide (NO) to the nitrogen dioxide (NO₂) at the temperature of 200° C. or more.

5. The diesel engine exhaust gas treatment system according to claim 2, wherein the second oxidation catalyst has formula RMnO₂, wherein R is one or more selected from La and Ag.

6. The diesel engine exhaust gas treatment system according to claim 2, wherein the first oxidation catalyst comprises: a composite oxide carrier including cerium (Ce); and a metal catalyst selected from the group consisting of palladium (Pd), platinum (Pt), rhodium (Rh), gold (Au), silver (Ag), ruthenium (Ru), and mixtures thereof.

7. The diesel engine exhaust gas treatment system according to claim 1, wherein the nitrogen oxide purification part comprises a selective catalytic reduction catalyst (SCR) for purifying the nitrogen oxide (NOₓ) included in exhaust gas or a diesel particulate filter (SDPF) coated with the SCR catalyst.
